(19) United States
(12) Patent Application Publication
(10) Pub. No.: US 2009/0016416 A1
(43) Pub. Date: Jan. 15, 2009

(54) SYSTEM AND METHOD FOR PROVIDING APPLICATION, SERVICE, OR DATA VIA A NETWORK APPLIANCE

(76) Inventors: Charles Stanley Fenton, Ypsilanti, MI (US); Gregory Robert Leitheiser, Coppell, TX (US)

Correspondence Address: RAMAN N. DEWAN;JACKSON WALKER, L.L.P., 100 CONGRESS AVENUE, SUITE 1100, AUSTIN, TX, 78701, US

(21) Appl. No.: 11/777,075

(22) Filed: Jul. 12, 2007

(51) Int. Cl. H04L 5/16

(52) U.S. Cl. 375/219

(57) ABSTRACT

A portable beacon for use in a local network having a network appliance and an end device includes a processor, persistent storage accessible to the processor, and an interface. The beacon registers with the appliance. Registration employs the beacon's hardware identification to identify the beacon uniquely. The beacon enables communication of information between the appliance and the end device whether the end device is a networked end device that is connected or connectable to the appliance or a sequestered device that is isolated from the appliance. The beacon may be a U3 compliant or other type of USB flash drive device. The beacon may be connected to an end system to identify the system as an authorized system for a service that is provisioned on the appliance. The beacon may also be used as a controllable data transport device between the appliance and a sequestered device.

### FIELD OF THE DISCLOSURE

The present disclosure relates generally to networked computing and, more specifically, the use of network appliances in a computer network.

### BACKGROUND OF THE DISCLOSURE

Network appliances are devices provided in an Ethernet or other suitable network, typically to make a dedicated and special purpose service or application available to the devices on the network. Provision of conventional appliance services usually includes downloading software from the appliance and/or a web browser. Adding and configuring software requires action and knowledge on the part of an administrator of the machine; a route for error exacerbating total cost of operation. When conventionally loaded software is no longer needed, effort is required to remove it from the system. This action may often be overlooked, leaving a facility open or accessible where it is no longer needed or required. Moreover, device identity, which may be useful to control distribution for licensing, security, and other purposes, is often tied to identifiers that change including MAC address, machine name, IP address, etc. In addition, conventional appliances do not offer a solution when a firewall is present between the systems and/or data of interest and the network appliance.

### BRIEF DESCRIPTION OF THE DRAWINGS

FIG. 1 is a block diagram illustrating selected elements emphasizing a use of a portable beacon in a first embodiment of a network;

FIG. 2 is a block diagram illustrating selected elements of an embodiment of a portable beacon;

FIG. 3 is a flow diagram illustrating an embodiment of a method of using a portable beacon in the network of FIG. 1;

FIG. 4 is a flow diagram illustrating an embodiment of another method of using a portable beacon in the network of FIG. 1;

FIG. 5 is a block diagram emphasizing an application for secure transfer of files between an external party and a second party using a portable beacon and a network appliance;

FIG. 6 is a flow diagram illustrating an embodiment of a method of using a portable beacon in the network of FIG. 5; and

FIG. 7 is a block diagram emphasizing an application for conveying infrastructure configuration information to a network appliance.

### DETAILED DESCRIPTION OF THE DRAWINGS

In one aspect, a portable beacon as disclosed is suitable for use in conjunction with a network that includes a network appliance and an end device. The portable beacon enables or otherwise facilitates controllable information transfer between the network appliance and the end device. The portable beacon includes a flash memory or another suitable persistent storage element, a mass storage controller or similar embedded processor or controller, and a connector and interface suitable for connecting the portable beacon to a bus or network. The portable beacon may be implemented as a U3 compliant USB flash drive suitable for attaching the portable beacon to a USB port of one or more other computing devices.

In some embodiments, a network appliance and an end device are connected via or capable of establishing an IP-based or other type of network connection. In these embodiments, the end device is referred to herein as a spoke device and the portable beacon may be used to establish or authorize communication paths between the network appliance and the spoke device. The portable beacon is plugged into or otherwise inserted in an appropriate port or connector of the network appliance. The portable beacon is configured to register itself to the network appliance when it is plugged into the network appliance. During the registration process, the portable beacon may provide a unique identifier to the network appliance that enables the network appliance to distinguish the inserted portable beacon from other portable beacon's. The portable beacon may then be hand carried or otherwise physically transported from the network appliance to a spoke device. When the portable beacon is plugged into the spoke device, the spoke device may extract the unique identifier from the portable beacon and use the identifier to present itself to the network appliance. When the network appliance recognizes the identifier coming from a particular spoke device, the network appliance may enable the spoke device to invoke or otherwise access a service or application program that is provisioned on the network appliance. In some embodiments, the spoke device is able to access the service on the network appliance only as long as the portable beacon remains with the spoke device. If the portable beacon is removed, the link between the network appliance and the portable beacon is terminated and the spoke device cannot invoke the service. In other embodiments, the service may remain accessible to the spoke device even after the portable beacon is removed. In these embodiments, the portable beacon may be configured to be able to authorize multiple spoke devices to have access to the network appliance and the service residing there.

The network appliance may acquire the service or application program in a variety of ways. The service may be provided by a service provider that is networked to the network appliance through a public or other form of external network including, as an example, the Internet. In some embodiments, the service or application program is pre-installed on the portable beacon by the service provider before the portable beacon is distributed. In other embodiments, the network appliance downloads the service from the service provider when the portable beacon is plugged into the network appliance. In other embodiments, the service or application program is installed on the portable beacon and downloaded from the portable beacon to the network appliance when the portable beacon is plugged into the network appliance.

In some embodiments, there is no network connection between the network appliance and the end device. In these embodiments, the end device is referred to herein as a sequestered device. In these embodiments, the portable beacon may be used to facilitate secured transfer of information from the sequestered device. After the portable beacon is registered with the network appliance, the portable beacon is plugged into a sequestered device. The sequestered device stores one or more of its files or other data to the storage resource of the portable beacon. The portable beacon may then be transported back to the network appliance. When the portable beacon is plugged back into the network appliance, the network appliance determines that the registration information matches the information in the portable beacon and the network appliance may then download the files or other data from the portable beacon.

In one aspect, a method of using a portable beacon to facilitate delivery of a service or application to a spoke device using a network appliance as an intermediary is disclosed. In some embodiments, the portable beacon is first plugged into the network appliance to register the portable beacon with the network appliance. The network appliance is configured with a service that is to be provided to the spoke device. The service can be installed or otherwise provisioned on the network appliance in a number of ways. The network appliance may be preconfigured with the service, receive the service from a service provider over a network, or download the service from the portable beacon itself. The portable beacon may then be removed from the network appliance and plugged into the spoke device. The portable beacon includes a module that enables the spoke device to introduce itself to the network appliance thereby enabling the spoke device to invoke the service. The spoke device may extract a hardware identifier of the portable beacon and present this identifier to the network appliance as part of the introduction. The spoke device's ability to invoke the service might remain only while the portable beacon is plugged into the spoke device. In these embodiments, removal of the portable beacon terminates the connection between the network appliance and the spoke device and the spoke device's ability to invoke the service. The portable beacon may include additional functionality enabling the spoke device, for example, to report its status or health to the network appliance and/or the service provider.

In another aspect, the portable beacon enables secured transfer of data between a sequestered device and a network appliance. In some embodiments, the network appliance may located exterior to an inside or corporate firewall associated with the spoke device. The network appliance may reside on the same side of an outside or DMZ firewall that prevents the transfer of data between the spoke device and the network appliance. After the portable beacon is registered with the network appliance, the portable beacon may be plugged into the sequestered device. The sequestered device may then transfer data to the portable beacon's storage resource. The portable beacon may then be brought back to the network appliance where the data can be downloaded from the portable beacon. The hardware identification resources of the portable beacon may be used to prevent the data on the portable beacon from being downloaded to a different network appliance thereby enabling control over dissemination of the stored data. In a variant of this configuration, the spoke device may not be networked to the network appliance at all because, for example, the spoke device is a highly secure device. In this configuration, the network appliance does not communicate with the spoke device, but the portable beacon provide a vehicle for transferring data to an identifiable resource (the network appliance).

In another aspect, the portable beacon may be used to facilitate networked transfer of files or data between two networked locations. A file may be transmitted from a sender to the network appliance of a recipient over a public network, preferably using a secure or encrypted connection. The portable beacon registers with the network appliance. When the portable beacon is then plugged into a spoke device, the user of the spoke device may have full or limited access to the files. When the portable beacon is unplugged, the spoke device's ability to access the file is terminated.

At least some of the disclosed embodiments facilitate the management and control of on-demand or other network distributed software that may be licensed on a per seat basis or a similar basis. Some embodiments make use of the portable beacon's hardware identity to provide a reliable identification mechanism for the spoke device.

In some embodiments where an executable application program is made available to an end device, the deployed application may require integration with other services provided on the network (e.g. databases, legacy systems). The portable beacon may be used to communicate connection, availability and configuration information to one or more such services. Consequently, the appliances can find services on the network and self configure to use them as necessary, further reducing the technical skill sets necessary to deploy appliance based services.

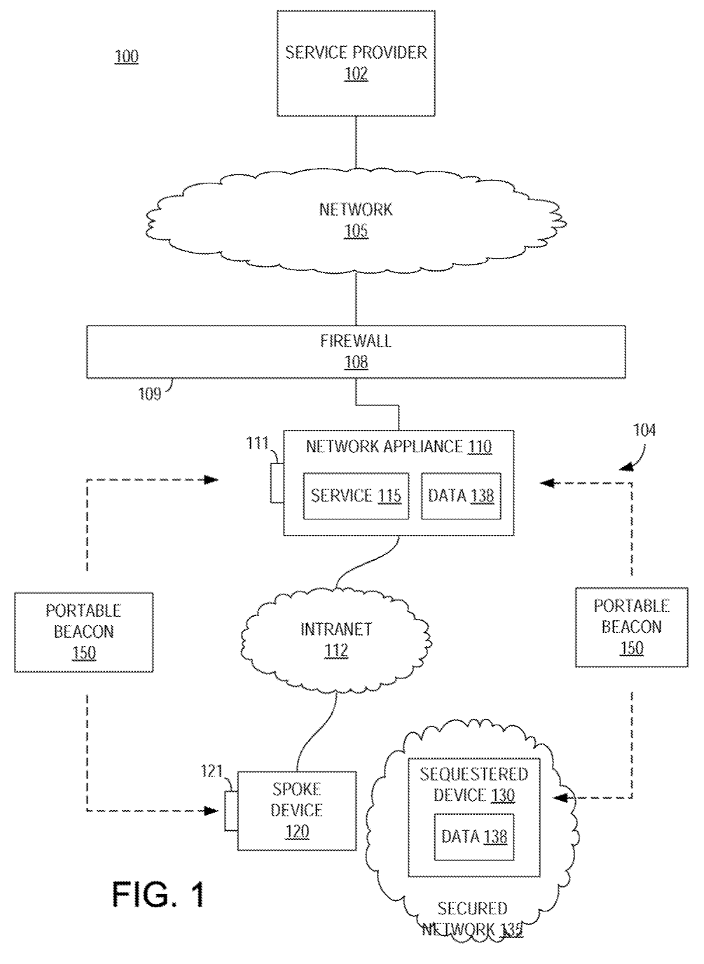

Referring to FIG. 1, selected elements of an embodiment of a system 100 are shown. System 100 as shown in FIG. 1 emphasizes an implementation operable to facilitate the provisioning of a service to an end system, referred to herein as spoke device 120, using a network appliance 110 and a portable hardware device, referred to herein as portable beacon 150, as intermediaries. In this implementation, system 100 is functional to provide complex services to spoke device 120 with plug-and-play style ease and explicit and reliable identification of the spoke device. In addition, system 100 as shown in FIG. 1 emphasizes an embodiment in which portable beacon 150 and network appliance 110 are used to facilitate controlled transfer of files or other data located on a sequestered device 130.

System 100 as shown in FIG. 1 includes a service provider 102 connected to an external network 105. Service provider 102 may include any type of web server, file server, database server, application server or the like. In some embodiments, external network 105 is or includes a public, packet-switched network such as the Internet. In other embodiments, external network 105 may be or include portions of a circuit switched network such as an ATM (asynchronous transfer mode) network or other type of network. Network 105 may include various types of network media including, as examples, twisted copper pair, optical fibers, and/or wireless media.

An outer firewall 108 is shown between external network 105 and a local network 104. Local network 104 includes a network appliance 110, a spoke device 120 connected or connectable to network appliance 110 via an intranet 112 and a sequestered device 130. Network appliance 110 represents any of a wide variety of devices that provide services for a network including, in the depicted configuration, intranet 112. Network appliance 110 may be implemented as a standalone and dedicated “black box” including hardware and installed software where the hardware is closely matched to the requirements and/or functionality of the software. Network appliance 110 may improve or increase the functionality and/or capacity of a network to which it is connected. Network appliance 110 may, for example, include functionality to perform e-mail tasks, security tasks, network management tasks including IP address management, and other tasks. In addition, network appliance 110 may be implemented as a DSL modem, a wireless access point, a router, or a gateway. Network appliance 110 generally does not expose its operating system or operating code to an end user and does not generally include conventional I/O devices such as keyboard or display. Network appliance 110 may, however, include software, firmware or other resources that support remote administration and/or maintenance of the appliance.

In some embodiments, end devices including spoke device 120 and sequestered device 130 represent general purpose computing devices such as a conventional desktop or notebook computers. More generally, spoke device 120 and sequestered device 130 encompass any network-aware information handling system capable of invoking a service, executing an application, storing a file or other data, or otherwise processing information. In the case of a general purpose computing device, spoke device 120 and sequestered device 130 may include conventional I/O hardware such as a display device, a keyboard, and a pointing device (none of which are explicitly depicted in FIG. 1).

Intranet 112 represents the physical media and supporting devices and software required to implement local network 104. Intranet 112 or portions thereof may be implemented as a conventional Ethernet-based TCP/IP local area network. Other implementations may use alternative physical media and/or protocol stacks.

In the depicted implementation, local network 104 encompasses the network environment that resides on a local side 109 of firewall 108. Local network 104 may represent, as examples, the internal network of a home, office, or large scale business. As such, local network 104 includes, in addition to the physical medium of the network, the necessary hardware devices and software modules to support and enable the network.

Firewall 108 represents one or more software or hardware based firewalls intended to prevent unauthorized access to intranet 112. In some embodiments, local network 104 may include its own firewall (not depicted in FIG. 1) that might segregate, for example, network appliance 110 from spoke device 120. Such an embodiment will be depicted and described in greater detail below.

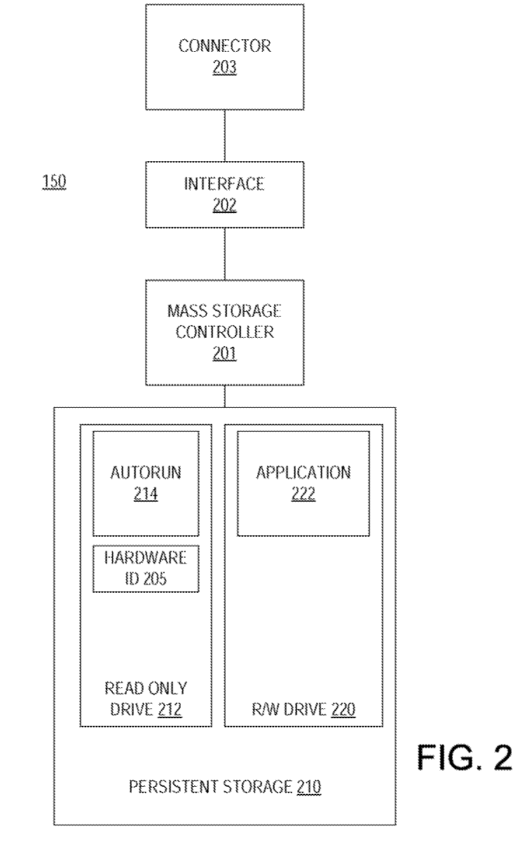

Referring to FIG. 2, selected elements of an embodiment of the portable beacon 150 depicted in FIG. 1 are shown. In the depicted embodiment, for example, portable beacon 150 includes a mass storage controller 201 connected to an interface 202 and a persistent storage resource 210. Persistent storage resource 210 is or includes one or more nonvolatile memory elements that may be implemented with flash memory or another suitable persistent memory technology. In some embodiments, persistent storage resource 210 has storage capacity in the range of approximately 32 MB to 64 GB.

Interface 202 enables communication between mass storage controller 201 and an external device, bus, or network via connector 203. In some embodiments, portable beacon 150 is operable to communicate with other devices via a standardized interconnect protocol. In a USB (Universal Serial Bus) embodiment, for example, connector 203 is a USB compliant connector and interface 202 enables mass storage controller 201 to communicate with external devices via a USB interconnect.

The embodiment of portable beacon 150 shown in FIG. 2 includes elements of a U3 smart drive. A U3 smart drive is a USB flash drive in which mass storage controller 201 partitions persistent storage resource 210 into two drives. A read only drive 212 emulates a CD ROM drive and typically includes an autorun module 214 having code that executes automatically when the portable beacon is plugged into a USB port or otherwise connected to a USB compliant bus. A second drive, referred to as read/write drive 220, is a conventional FAT (File Allocation Table) partition suitable for storing files, application programs and other data. As shown in FIG. 2, for example, an application program 222 is stored in read/write drive 220. It should be appreciated that autorun module 214 and application program 222 may be implemented as a set of computer executable instructions embedded or otherwise stored in persistent storage resource 210.

Autorun module 214 may include functionality to distinguish the type of device that portable beacon 150 is connected to. Autorun module 214 may include, as an example, a preliminary routine that detects connection of portable beacon 150 to a device and determines whether the device is a network appliance, an end device, or another type of system. Autorun module 214 may further include additional instructions or modules to perform specified functions when executed. Thus, for example, autorun module 214 may include code that registers portable beacon 150 with a network appliance when the portable beacon is first connected to portable beacon 150. Similarly, autorun module 214 may include functionality to present an end device to network appliance 110 when portable beacon 150 is connected to an end device that is networked.

Portable beacon 150 as shown in FIG. 2 includes a hardware identification (ID) 205 that is accessible to mass storage controller 201. Hardware ID 205 is preferably a read-only number or alphanumeric string that identifies an individual portable beacon 150. In some embodiments, no two portable beacons 150 have the same hardware ID 205 so that hardware ID 205 may be used to distinguish, for example, an authorized portable beacon 150 from any other portable beacon. Although FIG. 2 depicts hardware ID 205 as being stored or embedded in read-only drive 212, other implementations may employ a distinct storage device or other type of device for storing hardware ID 205.

Returning to FIG. 1, system 100 supports an application in which portable beacon 150 facilitates communication between network appliance 110 and spoke device 120. Portable beacon 150 may be inserted or plugged into network appliance 110 as well as spoke device 120. In U3 and other USB-based implementations, for example, the connector 203 of portable beacon 150 is a USB connector that can be inserted into a USB port 111 on network appliance 110 or a USB port 121 on spoke device 120. The broken lines shown in FIG. 1 extending from portable beacon 150 towards network appliance 110 and spoke device 120 emphasize the use of portable beacon 150 in a process of enabling spoke device 120 to access a service 115 on network appliance 110.

In some embodiments as shown in FIG. 1, service provider 102 provides a service 115 to spoke device 120 using network appliance 110 and portable beacon 150 as intermediaries. In these embodiments, network appliance 110 is configured with a service 115, which may represent one or more application programs, database files, and/or other types of stored information. In at least some of these embodiments, service 115 represents a service that is required or preferred to execute on a resource such as network appliance 110 that lies within the boundaries of an entity's firewall 108 because, for example, the nature of the service raises confidentiality or security issues.

Service 115 may be pre-loaded or pre-installed on network appliance 110 by service provider 102 or another before network appliance 110 is sold, leased, or otherwise distributed to the end user. Alternatively, service 115 may be installed on network appliance 110 after network appliance 110 is placed in the field. For example, service 115 may be downloaded to network appliance 110 from service provider 102 or a file server (not shown) under the domain or control of service provider 102 or another. In another alternative, service provider 102 may provision service 115 on network appliance 110 by installing service 115 on portable beacon 150. When portable beacon 150 is later plugged into network appliance 110, service 115 may be transferred from portable beacon 150 to network appliance 110. The manner in which service 115 is loaded onto network appliance 110 is an implementation decision. Tradeoffs are involved in selecting among all of the described alternatives.

Provisioning system 100 to enable spoke device 120 to invoke or otherwise access service 115 as depicted in FIG. 1 includes registering portable beacon 150 to network appliance 110. In some embodiments, this registration is achieved by inserting portable beacon 150 into network appliance 110. In these embodiments, portable beacon 150 is operable to respond to insertion into network appliance 110 by identifying itself to network appliance 110. In some embodiments, registering a portable beacon 150 includes network appliance 110 detecting and storing the hardware ID 205 of portable beacon 150. After a portable beacon 150 is registered with network appliance 110, portable beacon 150 may, in some embodiments, contain code that executes to open a network connection between network appliance 110 and another party, for example, service provider 102. This connection may be used to enable service provider 102 to recognize and/or monitor activity on network appliance 110, install or otherwise configure service 115 on network appliance 110, or for a variety of other purposes.

After portable beacon 150 registers with network appliance 110, portable beacon 150 may be removed from network appliance 110, physically transported to spoke device 120, and inserted into spoke device 120. Portable beacon 150 is preferably enabled to respond to insertion in spoke device 120 by presenting spoke device 120 to network appliance 110 as a device that is authorized to invoke or access service 115. In some embodiments, spoke device 120 uses standard TCP/IP protocols to present itself to network appliance 110. As part of presenting itself to network appliance 110, spoke device 120 may present the hardware ID 205 of portable beacon 150 to network appliance 110. When network appliance 110 detects spoke device 120 presenting itself, network appliance 110 can extract hardware ID 205 and compare it against the hardware ID network appliance 110 stored when portable beacon 150 registered. If a hardware ID match occurs, network appliance 110 authorizes or otherwise allows spoke device 120 to invoke or access service 115. The use of portable beacon hardware ID 205 to authorize a spoke device offers reliability over implementations that might use other identifiers. Use of a spoke devices MAC address, for example, might vary with time if, as an example, a network interface card (NIC) of the spoke device is changed. Similarly, IP addresses of particular systems may vary with time and may provide a less than reliable indicator of the end device.

In some embodiments, the authorization to access service 115 may persist only so long as portable beacon 150 remains inserted in spoke device 120. In these embodiments, removal of portable beacon 150 terminates provision of service 115 to spoke device 120. In other embodiments, removal of portable beacon 150 does not terminate service 115 for spoke device 120. In these embodiments, network appliance 110 may continue to provide service 115 to spoke device 120 indefinitely, for a specified period of time, or until a predetermined event occurs. In some embodiments, for example, removal of portable beacon 150 from spoke device 120 does not terminate service 115 unless portable beacon 150 is inserted in another spoke device (not shown in FIG. 1) or until portable beacon 150 is inserted into N other spoke devices where N represents the number of seats licensed to invoke service 115 via portable beacon 150. In any of these embodiments, it will be recognized by those of ordinary skill in the art that the described implementations of portable beacon 150 offers the ability to deploy complex services to end systems with near plug-and-play ease with the ability to determine the end device explicitly and reliably.

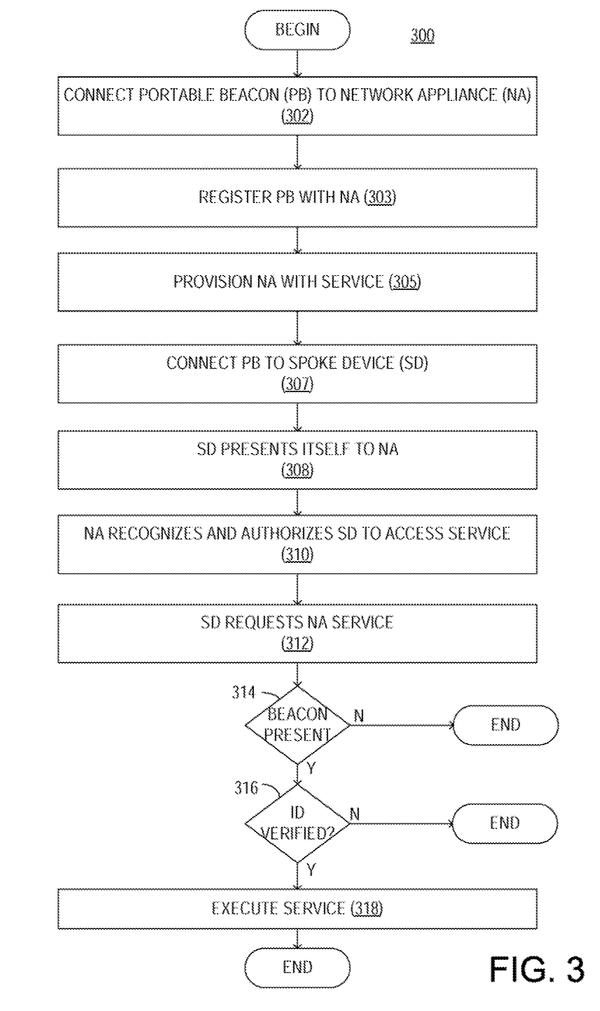

Referring to FIG. 3, a flow diagram illustrates elements of an embodiment of a method 300 of enabling a spoke device 120 to access a service 115 that is provisioned on a network appliance 110 to which the spoke device is or may be connected via a local network connection. Like other methods and modules disclosed herein, method 300 may be embodied as computer software, i.e., a set of computer executable instructions stored on a computer readable medium. The computer readable medium may include persistent storage and/or dynamic memory elements of network appliance 110 and/or spoke device 120. In addition, the software may be stored on or embedded in a removable medium such as a magnetic diskette, CD, DVD, USB flash drive, and so forth.

In the depicted embodiment, method 300 includes connecting (block 302) portable beacon 150 to network application 110. Connecting portable beacon 150 to network appliance 110 may include plugging portable beacon 150 into a USB or other suitable port or connector of network appliance 110. The portable beacon 150 responds to being connected to network appliance 110 by registering (block 303) with network appliance 110. Registering, as described above, may include portable beacon 150 providing and/or network appliance 110 extracting the hardware ID 205 from portable beacon 150. Registering portable beacon 150 preferably enables network appliance 110 to identify uniquely portable beacon 150 and any spoke device to which portable beacon 150 is subsequently connected.

Method 300 as shown further includes provisioning (block 305) network appliance 110 with a service 115. Service 115 may be a service that is distributed by service provider 102, but, as described above, must execute on a resource such as network appliance 110 that resides on local network 104, i.e., insulated from external network 105 by firewall 108. Although FIG. 3 depicts the provisioning of network appliance 110 with service 115 as occurring after registering portable beacon 150 with appliance 110, the sequence is an implementation detail and service 115 may be loaded, installed, or otherwise implemented on network appliance 110 before portable beacon 150 is plugged into network appliance 110. As described above, for example, service 115 may be preinstalled on network appliance 110 before network appliance 110 is distributed, service 115 may be provided directly from service provider 102 to network appliance 110, perhaps triggered by the insertion of portable beacon 150 into network appliance 110, or service 115 may be embedded in portable beacon 150 and installed in network appliance 110 when portable beacon 150 is plugged into network appliance 110.

Method 300 as shown includes connecting (block 307) portable beacon 150 to spoke device 120. After portable beacon 150 registers with network appliance 110, portable beacon 150 is removed from network appliance 110 and physically transported to the location of spoke device 120. Because network appliance 110 and spoke device 120 comprise elements of local network 104, the distance between the two may be relatively small, e.g., less than 30 meters while, in other embodiments, the distance between the two may be greater. In any event, when portable beacon 150 is inserted into spoke device 120, spoke device 120 may respond by presenting (block 308) itself to network appliance 110 as an authorized spoke device, i.e., a spoke device that is authorized to invoke service 115. In some embodiments, spoke device 120 presents itself by establishing a network connection with network appliance 110 if a network connection does not already exist. The portable beacon 150 may include information about network appliance 110 that assists spoke device 120 in establishing the connection including, as an example, an IP address or other form of network address for network appliance 110. The information about network appliance 110 may have been stored on portable beacon 150 when portable beacon 150 registered with network appliance 110.

In some embodiments, establishing a network connection with network appliance 110 and presenting spoke device 120 may include presenting identifying and/or authorization information to network appliance 110. In some embodiments, spoke device 120 identifies itself to network appliance 110 by sending the hardware ID 205 of portable beacon 150 to network appliance 110. When network appliance 110 receives authorization information that includes a hardware identifier that is uniquely associated with portable beacon 150, network appliance 110 recognizes that the portable beacon 150 is or was inserted in or otherwise connected to spoke device 120. Network appliance 110 may then recognize and/or authorize (block 310) spoke device 120 and thereby permit network appliance 110 to access service 115 on network appliance 110.

Method 300 as shown further includes spoke device 120 invoking (block 312) service 115 on network appliance 110. In the depicted embodiment, network appliance 110 responds to spoke device 120 attempting to access service 115 by performing one or more checks to verify that service 115 remains authorized to invoke the service. As shown in FIG. 3, for example, method 300 includes network appliance 110 determining (block 314) whether portable beacon 150 remains inserted in the appropriate port of spoke device 120 and, if so, whether the ID provided by the device is the hardware ID of spoke device 120. After determining (block 314) that a portable beacon 150 remains inserted in or otherwise connected to spoke device 120, method 300 as shown further includes network appliance 110 or another resource verifying (block 316) that the hardware ID of the portable beacon 150 is the correct ID thereby confirming that the portable beacon connected to spoke 120 is the portable beacon 150. After completing the optional verification blocks, method 300 includes executing (block 318) service 115, presumably on behalf of the network appliance 110 and service provider 102.

In some environments, a no-wire-in, no-wire-out policy might exist and preclude the transfer of information from a system. At least one of the disclosed embodiments addresses these environments even when the data exists on a sequestered device that is not connected to the network appliance. These embodiments would use file storage and resident software on the portable beacon to act as a temporary repository for data. This portable beacon repository could be encrypted if necessary and could further be restricted from access by passwords or similar facilities tied to the hardware ID of the network appliance. The portable beacon would be plugged into and collect the data from a sequestered device. When required, transfer of the data would include unplugging the portable beacon from the sequestered machine, transporting the beacon to the appliance, and plugging the beacon into the appliance. From the appliance, the information might be transferred across the network to a remote destination.

Turning now to FIG. 1, some embodiments emphasize the use of portable beacon 150 as a data transport device in conjunction with a sequestered device 130. Sequestered device 130 represents a server or other data processing system that resides on a secured network 135. Secured network 135 has no means for connecting to network appliance 110. In this environment, the data storage resources of portable beacon 150 can be employed to convey data between sequestered device 130 and network appliance 110. The hardware ID 205 of portable beacon 150 can be used in this application to restrict the network appliances that can access data 138 from sequestered device 130 so that access to the data is confined to a known device. When data 138 has been transported to network appliance 110 in this manner, the data can then be transmitted to external devices over external network 105.

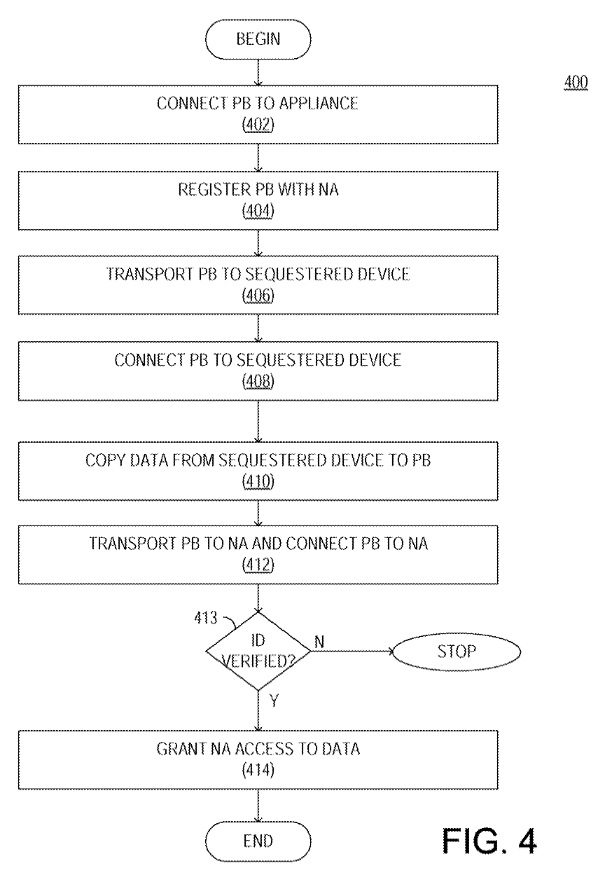

Referring to FIG. 4, a method 400 of leveraging portable beacon 150 as a data transport device in connection with a sequestered device is shown. In the depicted embodiment, method 400 includes connecting (block 402) portable beacon 150 to network appliance 110. The portable beacon 150 is enabled, once again, to register (block 404) with network appliance 110 when portable beacon 150 is plugged into or otherwise connected to network appliance 110. The registration of portable beacon 150 includes network appliance 110 detecting and retrieving the hardware ID 205 of portable beacon 150. The portable beacon 150 is then physically transported (block 406) to the sequestered device 130.

Sequestered device 130, as indicated above, resides on a secured network 135 that cannot be access from network appliance 110 because no network path between network appliance 110 and secured network 135 exists. The portable beacon 150 is plugged into or otherwise connected (block 408) to sequestered device 130. Sequestered device 130 detects portable beacon 150 as a data storage resource. Sequestered device 130 can then use portable beacon 150 to copy (block 410) data 138 from the sequestered device's native storage (not depicted explicitly) to portable beacon 150.

The portable beacon 150 is then transported (block 412) back to network appliance 110 and connected to the network appliance. When portable beacon 150 is connected to network appliance 110, network appliance 110 verifies (block 413) that the hardware ID of portable beacon 150 is a recognized hardware ID. If the hardware ID of portable beacon 150 is a hardware ID recognized by network appliance 110, access to data 138 stored in portable beacon 150 is granted (block 414) and network appliance 110 may then copy the data to its native storage and/or forward the data to a remote site via external network 105. Data 138 as it resides on portable beacon 150 may be encrypted and/or password protected to provide additional security for the data. In this manner, portable beacon 150 is used in conjunction with network appliance 110 to transport data from a sequestered device to a verifiable and externally accessible location in the form of network appliance 110.

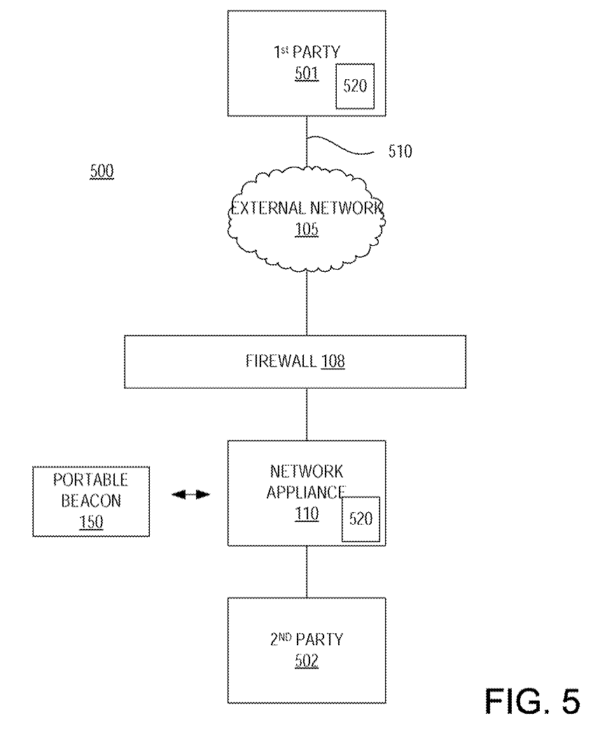

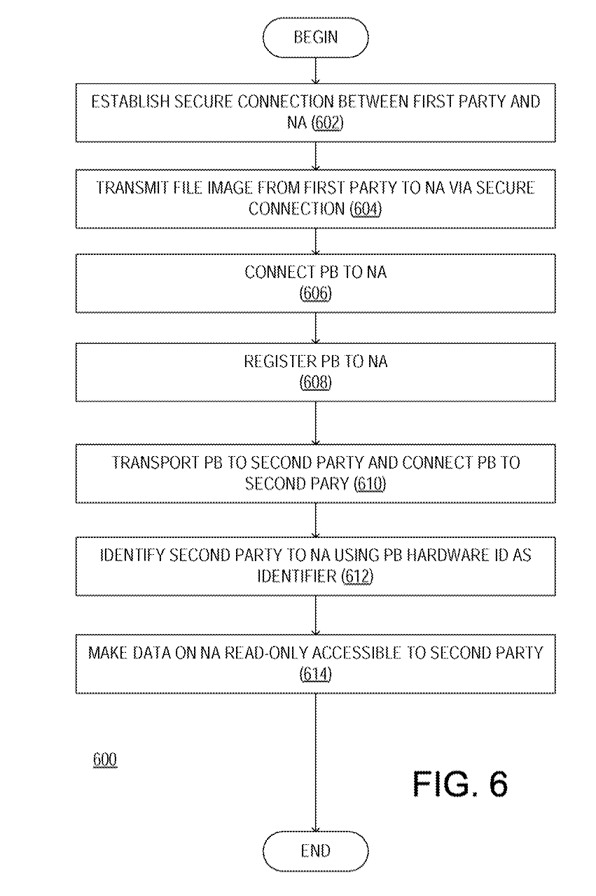

Turning now to FIG. 5 and FIG. 6, depicted are embodiments of a system 500 and method 600 emphasizing the use of portable beacon 150 and network appliance 110 for secured transfer of files or data from a first party located outside of a local network to a second party within the network. Referring to FIG. 5, the depicted embodiment of system 500 includes a first party 501 connected to external network 105. First party 501 establishes a secure connection 510 with network appliance 110. Secure connection 510 may be established by encrypting and/or applying additional security-related functions to a conventional TCP/IP connection.

After the secure connection 510 is established, first party 501 transmits a file or data 520 to network appliance 110. Network appliance 110 may then store data 520 in its local storage. In this case, network appliance 110 may be a black box device that is located, for example, within an office. A second party 502 is also located in the office and has an Ethernet or other form of local area network (LAN) connection with network appliance 110. It may be desirable for first party 501 to present data 138 to second party 502 without relinquishing control over the content and/or distribution of the file. Using portable beacon 150 and network appliance 110 as intermediaries facilitates this goal by providing a mechanism that enables an end user to access the document as it is located on an intermediary device while simultaneously enabling the first party to control the second party's access to the document.

When data 520 is stored on network appliance 110 and portable beacon 150 is connected to network appliance 110, portable beacon 150 registers with network appliance 110. In this case, the registration process may include the execution of code either stored in portable beacon 150 or resident on network appliance 110 that generates information from which a second party can determine that a document resides on its network appliance 110. The portable beacon 150 would then be disconnected from network appliance 110 and connected to second party 502 to identify second party 502 to network appliance 110 using the hardware ID 205 of portable beacon 150. When network appliance 110 is informed or otherwise discovers that second party 502 is an authorized end device, network appliance 110 may then make data 520 available to second party 502. In some implementations, network appliance 110 permits read-only access to data 520. In these implementations, data 520 is viewable, but cannot be modified by second party 502.

Referring to FIG. 6, a method 600 embodying the secure publication of data is illustrated. As shown in FIG. 6, method 600 includes establishing (block 602) a secure connection 510 between the first party 501 and network appliance 110 where network appliance 110 is located on a local network 104 that includes a second party 502. The local network 104 is separated from an external network 105 by one or more firewalls 108.

Data 520 is then transmitted (block 604) from first party 501 to network appliance 110 over secure connection 510 to network appliance 110. When it arrives at network appliance 110, the data may be saved to storage of network appliance 110. Data 520 is preferably encrypted and access to data 520 may require authentication to prevent unwanted access to data 520.

When a portable beacon 150 is connected (block 606) to network appliance 110, portable beacon 150 registers (block 608) itself to network appliance 110 as described in the preceding paragraphs. The portable beacon 150 may then be removed from network appliance 110, transported to the second party and connected (block 610) to second party 502. In some embodiments, connecting portable beacon 150 to second party 502 causes second party 502 to identify itself (block 612), using the hardware ID of portable beacon 150, to network appliance 110. When the second party 502 is identified as an authorized end device to network appliance 110, network appliance 110 permits second party 502 to access data file 520 (block 614). The access granted to second party 502 may be limited to read only access or another type of restricted access. Second party 502 may continue to access data file 520 until portable beacon 150 is removed from second party 502. When the portable beacon 150 is no longer connected to it, network appliance 110 may then terminate the ability of second party 502 to access data 520.

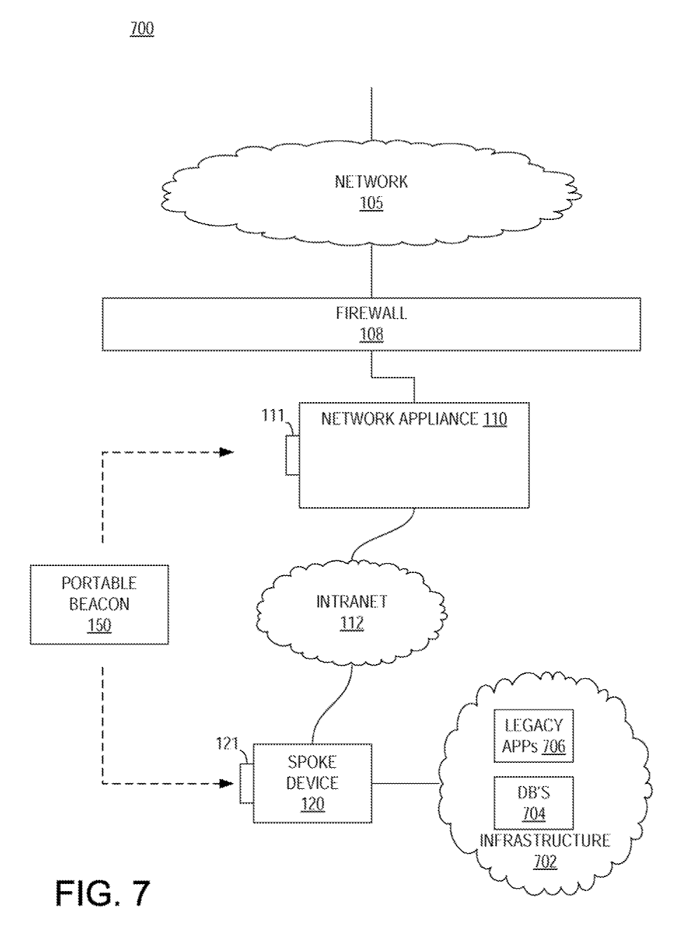

Turning now to FIG. 7, selected elements of an embodiment of a system 700 are shown. System 700 as depicted emphasizes functionality in which portable beacon 150 is used to convey configuration information about infrastructure associated with a spoke device. As depicted in FIG. 7, there is at least some infrastructure 702 associated with spoke device 120. Infrastructure 702 may include, as examples, legacy applications represented by reference numeral 706, databases 704, as well as other undepicted elements that are installed on or associated with spoke device 120. All or portions of infrastructure 702 may reside in spoke device 120 or in a resource, e.g., a network attached storage resource, is connected.

In some embodiments, portable beacon 150 is first plugged into network appliance 110 to convey identity information and possibly to install software on or otherwise configure network appliance 110. Portable beacon 150 is then transferred to spoke device 120 that hosts infrastructure 702. Portable beacon 150 automatically seeks out and detects configuration information about infrastructure elements including database(s) 704 and/or legacy application(s) 706 hosted by spoke device 120 and reports the configuration information back to network appliance 110. Network appliance 110 may then use the configuration information to configure itself to access, invoke, or otherwise use infrastructure elements 702 of spoke device 120.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

In accordance with various embodiments, the methods described herein may be implemented as computer program products or software programs. In these embodiments, the program product or software programs include computer executable instructions stored on a computer readable medium being executed by a computer processor. The computer readable medium may include persistent storage, e.g., hard disks or other magnetic storage, removable media including floppy diskettes and optical disks, and other forms of persistent storage such as flash memory or other electrically erasable persistent storage. The computer readable media my also include volatile computer memory including system memory, cache memory, and the like. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R Section 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

What is claimed is:

1. A portable beacon suitable for use in a local network including a network appliance and an end device, the portable beacon including a processor, persistent storage accessible to the processor, and an interface, wherein the portable beacon is operable to register with the network appliance when the portable beacon is connected to the network appliance thereby enabling the network appliance to identify the portable beacon uniquely and further wherein the portable beacon is operable to enable communication of information between the network appliance and the end device.

2. The portable beacon of claim 1, wherein the portable beacon comprises a USB flash drive device.

3. The portable beacon of claim 2, wherein the portable beacon is a U3 flash device.

4. The portable beacon of claim 1, wherein the portable beacon facilitates an information transfer between the network appliance and an end device comprising a spoke device connected to the network appliance via a network connection between them.

5. The portable beacon of claim 4, wherein the portable beacon includes a unique identifier and wherein identifying the spoke device to the network appliance includes the spoke device extracting the unique identifier from the portable beacon and presenting the unique identifier to the network appliance.

6. The portable beacon of claim 1, wherein the portable beacon is operable to facilitate an information transfer between the network appliance and an end device comprising a sequestered device that is not networked to the network appliance.

7. The portable beacon of claim 6, wherein the portable beacon is operable to store data from the sequestered device and further operable to permit access to the stored data when the portable beacon is subsequently connected to the network appliance.

8. The portable beacon of claim 7, wherein the portable beacon and the network appliance are not connected via any network.

9. The portable beacon of claim 8, wherein the portable beacon and the network appliance reside on different sides of a firewall.

10. The portable beacon of claim 1, wherein the portable beacon is operable to permit access to a file, stored on the network appliance of a local network, to a second party of the local network.

11. A method of providing a service in a computer network comprising a spoke device and a network appliance wherein the spoke device and the network appliance are operable to establish a network connection between them, comprising:
enabling a network appliance to provide the service to identified spoke devices;
enabling a portable beacon to respond to being inserted into the network appliance by registering with the network appliance; and
enabling the portable beacon to respond to being inserted into the spoke device by identifying the spoke device to the network appliance and thereby enabling the spoke device to access the service.

12. The method of claim 11, wherein enabling the network appliance to provide the service comprises installing the service on the network appliance.

13. The method of claim 12, wherein the service is embedded in storage of the portable beacon and wherein enabling the network appliance includes downloading the service from the portable beacon to the network appliance when the portable beacon is inserted in the spoke device.

14. The method of claim 12, wherein the service is provided by a service provider via the computer network and wherein enabling the network appliance includes downloading the service from the service provider to the network appliance when the portable beacon is inserted in the spoke device.

15. The method of claim 12, wherein enabling the network appliance to provide the service comprises pre-installing the service on the network appliance prior to distributing the network appliance to a user.

16. The method of claim 11, wherein said portable beacon registering with the network appliance includes said network appliance retrieving a unique identifier of the portable beacon.

17. The method of claim 11, wherein said identifying of said spoke device comprises said spoke device retrieving said unique identifier from said portable beacon and presenting said unique identifier to said network appliance.

18. The method of claim 11, wherein said spoke device comprises a processor in communication with a persistent storage resource.

19. The method of claim 18, wherein said portable beacon comprises a USB flash drive.

20. The method of claim 19, wherein said portable beacon is U3 compliant.

21. A computer program product comprising computer executable instructions, stored on a computer readable medium of a portable beacon, for facilitating a transfer of information between a network appliance and an end device, the instructions comprising instructions to:
respond to connecting the portable beacon to the network appliance by registering the portable beacon with the network appliance including providing the network appliance with a hardware ID unique to the portable beacon;
respond to connecting the portable beacon to an end device by performing a step selected from the group consisting of (1) identifying the end device to the network appliance as an authorized end device via a network connection between the network appliance and the end device and (2) providing a storage resource to the end device wherein the access to the storage resource is restricted to the end device and the network appliance.

22. A method of employing a portable beacon to enable an end device in a local network to communicate with a network appliance on the local network, comprising:
configuring the portable beacon to respond to connecting to the network appliance by registering with the network appliance, wherein registering includes providing a unique identifier of the portable beacon to the network appliance;
configuring the portable beacon to respond to connecting to an end device by performing a step selected from the group consisting of (1) identifying the end device to the network appliance as an authorized end device via a network path between the network appliance and the end device and (2) providing a storage resource for receiving data from the end device, wherein the received data is accessible only to the end device and the network appliance.
